(19) United States
(12) Patent Application Publication
(10) Pub. No.: US 2025/0340316 A1
(43) Pub. Date: Nov. 6, 2025

(54) METHOD FOR PRODUCING A PACKAGING FROM A RECYCLABLE MATERIAL

(71) Applicant: SOCIETE DES PRODUITS NESTLE S.A., Vevey (CH)

(72) Inventors: RAFAEL SCHRAML, Sugiez (CH); LUIS FERNANDO RUEDA, Munsingen (CH); ANDREA RIGARDO, Prilly (CH)

(21) Appl. No.: 18/867,509

(22) PCT Filed: May 24, 2023
(86) PCT No.: PCT/EP2023/063951

§ 371 Date: Nov. 20, 2024

(30) Foreign Application Priority Data
May 24, 2022 (EP) 22174993.0

(51) Int. Cl. B65B 9/20; B65B 41/12; B65B 51/04; B65B 51/26

(52) U.S. Cl. CPC B65B 9/20; B65B 41/12; B65B 51/04; B65B 51/26

(57) ABSTRACT

The invention relates to a method for producing a packaging (100) for enclosing a substance (S). A flat sheet (110) made of recyclable material and having two opposite side edge sections (111, 112) is provided and formed into a tube (130) by folding the flat sheet (110) so that the two side edge sections (111, 112) overlap each other at an overlapping section (139). The tube (130) is heat sealed along the overlapping section (139) to form a longitudinal sealing joint (131) and heat sealed across the longitudinal sealing joint (131) to close the tube (130) with a first traverse sealing joint (134) at a first tube end (132). The tube (130) is filled with the substance (S) and heat sealed across the longitudinal sealing joint (131) to close the tube (130) with a second traverse sealing joint (135) at a second tube end (133). A sealing strip (700) that is heat-sealable is provided. A first and second segment (701, 702) of the sealing strip (700) is provided at a first and a second triple point section (171, 172), where the longitudinal sealing joint (131) and the respective traverse sealing joints (134, 135) intersect, respectively. The segments (701, 702) of the sealing strip (700) seal the respective triple point section (171, 172) upon heat sealing of the respective tube end (132, 133) to form the respective traverse sealing joint (134, 135). The invention also relates to a packaging (100) enclosing a substance (S) and a machine (500) for producing the packaging (100).

### 1. FIELD OF THE INVENTION

The present invention relates to a method for producing a packaging by providing a flat sheet, folding the flat sheet into a tube, filling the tube with a substance and heat sealing sections of the tube to enclose the substance inside the packaging. The invention further relates to a packaging enclosing a substance and a machine for producing the packaging.

### 2. TECHNICAL BACKGROUND

Commonly, a majority of single- and multi-serve packaging for food products is made from non-sustainable materials, such as petroleum-based plastics, for which reusing, recycling or composting generally is a challenging process. On the other hand, it is an advantage of such materials that packaging can be produced with them, which reliably and hermetically seals the food product inside the packaging from external substances, such as microbes or oxygen, which increases the shelf-life of the packaged products.

In the prior art, various attempts were undertaken to reduce the ecological impact of food packaging, for example, by finding alternatives for said established materials, such as recyclable, biodegradable, or compostable polymers, laminates or paper. However, this proves to be challenging as food-packaging applications generally place stringent requirements on various characteristics of the packaging materials, such as the barrier performance of the packaging, which is of relevance for keeping the packaged product's aromas, freshness and integrity intact over the entire intended shelf-life. Moreover, it is often necessary that the new materials match or even exceed the material characteristics of the established materials with respect to flexibility, durability and weight. Also, different manufacturing methods for producing the packaging are often required because the alternative materials may differ from those of established materials in characteristics relevant for forming and sealing the packaging.

For example, it is possible to provide a pillow packaging from established materials such that the content inside the respective package is hermetically sealed. Typically, this type of packaging is produced in an automated vertical or horizontal form fill sealing process (in the following abbreviated as: VFFS or HFFS). By providing a hermetically sealed packaging, the risk of biological degradation from bacterial contamination, oxidation or moisture can be reduced. In comparison, the provision of a pillow packaging made from a paper or a recyclable polymer or a recyclable laminate usually does not allow to reliably and consistently provide the packaging with a hermetical sealing.

A reason for this is that it is a major challenge in VFFS or HFFS applications to achieve tight seals in a so-called “triple point area” of the packaging. In the triple point area, a longitudinal seal is crossed by a horizontal seal, which, for example, seals one of the two opposite ends of a packaging. The crossing of the longitudinal and horizontal seals leads to a configuration, where locally four layers of material exist before being combined and reduced to two layers. FIGS. 1 to 3 and 6 indicate exemplarily the triple point area (11) and its configuration of the layers of material in a pillow packaging (10) of the prior art. As visualized by FIGS. 2, 3 and 6, it is difficult to completely and reliably seal the triple point areas (11) when providing the horizontal seal (16, 16) as the localized material accumulation and varying packaging height at the intersection between longitudinal seal (14) and horizontal seal (16, 16) impact the effectiveness of the sealing process and the sealing result. Thermal conductivity is reduced by the material accumulation and a larger amount of sealant is locally required to fill a gap (15) existing at the triple point area (11), which has similar negative effects as a through hole. Due to these circumstances, the triple point area (11) is a main source of leakages in pillow packaging but also in any other (pouch-type) packaging that comprises a triple point area, such as stickpacks or gusseted pouches.

Such negative effects are often further aggravated by using any of the aforementioned alternative materials. For example, the material stiffness and thickness of sustainable paper materials or laminates is often higher than of the established materials, which makes it difficult to uniformly distribute heat and pressure during the sealing process at the triple point area. In addition, sustainable laminates and/or paper often have a lower heat conductivity than existing non-recyclable laminates. Moreover, paper laminates usually have only a very thin sealing layer to allow for recycling in the paper stream. Accordingly, only a limited amount of sealant can be used to fill the gap at the triple point area. For these reasons, it is challenging to achieve with recyclable packaging a reliable and strong sealing at the triple point.

The issues and disadvantages of packaging comprising a triple point area are known in the prior art and existing attempts to overcome these issues are briefly described below:

For example, it was attempted to overcome issues relating to the triple point area by providing a horizontal sealing tool that is specifically designed to compensate for the four material layers existing in the triple point area. In the design, the sealing tool has a surface, where locally material with a thickness corresponding to twice the thickness of the laminate used for the packaging is removed to form a fin seal relief. Unfortunately, a problem with this approach is that the longitudinal seal might slightly move in the running of a VFFS or HFFS machine, which may cause that the fin seal relief of the sealing tool is not always aligned with the triple point area, leading to a further aggravation of the problems of providing tight and reliable sealing.

In an alternative approach, flexible sealing tools are provided, which are commonly used for cold seal applications. Therein, for example, one side of the sealing tools is made from a flexible material, like Aramid fibres. A drawback of this approach is that it is not possible to heat both of the two sealing tools, which reduces the heat transfer for melting the sealant so that the problems relating to sealing tightness and reliability are further aggravated. In addition, the soft material can lead to a reduction of the life time of the sealing tool when being used in a VFFS or HFFS machine.

In a different approach, it was attempted to overcome the aforementioned problems by providing the entire surface of the packaging material with a sealing layer that has a higher thickness than commonly provided. Alternatively or additionally, a layer of special sealing polymers that require only a low sealing initiation temperature are used. However, such laminates are considerably more expensive than the usual laminates. Moreover, the special sealing polymers with their advantageous properties are only needed on a small portion of the packaging material, namely at the triple point area. Accordingly, this approach is neither resourceful nor can be considered sustainable. In addition, if a paper material is to be used, it has to be considered that the packaging can be recycled only if it contains a limited amount of adhesives or sealants. Unfortunately, this amount is often exceeded with this approach.

In an alternative approach, such as described in WO 2022/064058 A1, it was attempted to overcome the aforementioned problems by injecting an amount of hot glue on the surface of the packaging material in triple point areas before forming the packaging. Unfortunately, this approach requires a very accurate application of the hot glue at the respective triple point area to ensure that leakages of the packaging can be prevented.

In addition, the use of hot glue can be problematic when coming into contact with food products and thus, may be less suitable for a range of food packaging applications.

From the above, it becomes clear that all of the above solutions known from the prior art have constraints or disadvantages and thus, there is a need to address at least some or all of the challenges existing in producing a recyclable and sustainable packaging.

Therefore, it is an object of the present invention to provide a method for producing a recyclable packaging from a recyclable sheet material that allows to hermetically seal the packaging, that is fully recyclable, and that facilitates that existing machinery can be used for producing said packaging with no, or with simple or minor modifications.

### 3. SUMMARY OF THE INVENTION

These and other objects, which become apparent upon reading the description, are solved by the subject-matter of the independent claims. The dependent claims refer to preferred embodiments of the invention.

A first aspect of the invention relates to a method for producing a recyclable packaging for enclosing a substance. In the method, a flat sheet is provided. The flat sheet is made of a recyclable material and has two opposite side edge sections.

Therein, the expression “flat sheet” may be understood as a portion of a material that may be thin in comparison to its length and may have at least one even surface, for instance. The expression “recyclable” may be understood, for example, as a material that can be reused entirely for a new product or purpose after being treated mechanically and/or chemically using an industrial or natural process. For example, the sheet material used in the invention may be collected after usage and may be mixed with water and chemicals. It is heated up and broken up. Plastic coatings and ink may be removed as long as they do not exceed a certain amount, for example by filtering. Therein, to recycle a paper material successfully in the paper stream, the amount of a plastic coating on the recycled material or the amount of polymer content in the recyclable material may only be up to about 5% of its total weight.

The flat sheet is formed into a tube by folding the flat sheet so that the two side edge sections at least partially overlap each other at an overlapping section. The tube is heat sealed along the overlapping section to form a longitudinal sealing joint. Further, the tube is heat sealed across the longitudinal sealing joint to close the tube with a first traverse sealing joint at a first tube end. The tube is filled with a substance to be packed.

Therein, the expression “substance” may be understood, for example, as any type of solid, liquid, at least partially soluble and/or percolate-able matter, which may have a particular or definite chemical constitution. Examples for substances may be cosmetic, medical or food products, preferably powdered (food) products or dehydrated edible substances, such as infant formula, infant cereals, cereals, powdered coffee, soluble coffee, or dairy products, e.g. coffee creamers.

The tube is heat sealed across the longitudinal sealing joint to close the tube with a second traverse sealing joint at a second tube end, which is opposite to the first tube end with respect to the substance to be packed, so as to form the packaging enclosing said substance.

A sealing strip is provided. The sealing strip is heat-sealable.

Therein, the expression “strip” may be understood, for example, as a long, narrow, thin piece of material compared to the sheet material, tube and/or finished packaging.

The sealing strip is provided such that a first segment of the sealing strip is provided at a first triple point section, and a second segment of the sealing strip is provided at a second triple point section. At the first triple point section, the first traverse sealing joint intersects with the longitudinal sealing joint. At the second triple point section, the second traverse sealing joint intersects with the longitudinal sealing joint. The respective segments of the sealing strip seal the respective triple point section upon the heat sealing of the respective tube end to form the respective traverse sealing joint.

In other words: the present invention provides a method that facilitates the production of a packaging that reliably encases, wraps or covers the substance to be packed in a (hermetically) sealing manner but that can be recycled easily after its usage.

For this, the method stipulates to provide an even, thin in comparison to its length portion of a recyclable material that has two side edge sections opposite to each other. Therein, a side edge section may be understood, for example, as any part or portion of the flat sheet that extends from one of the two opposite side edges towards the other side edge. The method provides further to fold the flat sheet into a tube by folding the flat sheet such that the two side edge sections at least partially overlap. Thus, the two side edge sections may be arranged in the folded state such that they may extend over each other such that they may both cover a portion of the tube, which may be the overlapping section. Therein, it is also conceivable that one of the side edge sections may project/overhang the other one in the folded state. Thus, while not being excluded, it is not required for the two side edges to be arranged flush with each other. In the overlapping section, the side edge sections may face each other with the same side of the flat sheet. Preferably, the overlapping section can be formed such that it protrudes from the packaging. Preferably, the overlapping section can be formed such that both side edge sections or the overlapping section are positioned at an outer side of the packaging.

The tube is then to be sealed lengthwise by heat sealing. Thus, in this instance, the sealing direction may comprise at least one component corresponding with the longitudinal axis of the tube. During heat sealing, heat and/or pressure may be applied to influence the material of the surfaces to be sealed. The two ends of the tube are heat sealed across the longitudinal sealing joint with traverse sealing joints, respectively. Therein, the traverse sealing joints may run in an oblique or winded manner relative to the longitudinal sealing joint so that it is not necessary (while not being excluded at the same time) that the traverse sealing joints are (straight and/or) orthogonal to the longitudinal sealing joint. Thereby, it is possible to enclose/encase/wrap the substance, which is filled into the packaging, from all sides. Naturally, there is no limitation on the number of traverse and longitudinal sealing joints, as well as on the number of triple point sections.

A heat-sealable sealing strip is supplied and made available in the production of the packaging. Thereby, it is possible to provide a strip of material, such as a film, band or tape, that may have good sealing properties and/or that may be further utilized under the application of heat and/or pressure. For example, the sealing strip may act as facilitator to seal different surfaces and/or as a reservoir to supply additional sealant material upon activation through heat and/or pressure. Segments of the sealing strip are arranged inside (within) the tube. Therein, the segments may be separate (e.g. cut off) or integral portions or sections of the sealing strip, for instance. The segments are provided at the triple point sections. Therein, a triple point section may be understood, for example, as a space or an area in and around the triple point, where a traverse sealing joint is destined to intersect or intersects with a longitudinal sealing joint. A segment may, for example, at least partially adjoin a triple point section, and/or extend, overlap, lie within and/or (fully) cover the triple point section. Upon performing heat sealing for forming a traverse sealing joint, a segment of the sealing strip may be activated by heat (e.g. it may be melted) and it may supply sealing material for connecting the material layers of the tube at the triple point section and for filling and closing gaps in the transverse sealing joint, which, for example, may be created due to the localized accumulation of the different material layers at the triple point section. Thereby, a segment may seal the triple point section so that passage of external substances, like gas, moisture or microbes, into the packaging can be prevented.

Hence, with the configuration of the invention, (additional) sealing material can be provided directly at the triple point area. Thus, sealing material can specifically be provided in parts of the packaging that are in need of additional sealing material for ensuring reliably sealed packaging, so that, for example, vacuum tight packaging can be provided. Thus, the shelf-life of the so packaged products can be ensured and improved. Moreover, the amount of additional sealing material in the packaging can be kept at a low level so that the packaging still can be recycled. Further, the amount of additional sealing material in the triple point area can be easily controlled by defining the thickness of the sealing strip. Accordingly, unlike with the glue application of the prior art, there is no need to provide a complex dosing system to implement the method of the present invention. Moreover, the configuration of the invention can reduce the overall amount of sealing material contained in the packaging because the amount of sealing material can be reduced in parts of the packaging that do not require high levels of sealing material for providing high sealing tightness. Also, the configuration of the invention facilitates the use of sustainable alternative materials for the packaging that otherwise are considered unsuitable for sealing a triple point area (for instance, because of their low content of sealing material or low heat conductivity). Additionally, the method can be applied to a wide range of packaging applications and material combinations without having to take the particulars of the design of the packaging into consideration. Further, production of the packaging with VFFS or HFFS machines can be simplified and accelerated with the concept of the invention since a sealing strip can be provided simultaneously with processing the flat sheet material. Moreover, the method can be implemented on existing machines without requiring extensive modifications.

Hence, the method of the invention overcomes the aforementioned prior art problems.

According to a preferred embodiment, the respective segments of the sealing strip may be provided before or during the step of forming the flat sheet into a tube. Alternatively or additionally, the respective segments of the sealing strip may be provided before or during the step of heat sealing the longitudinal sealing joint.

According to a further preferred embodiment, at least one of the steps of providing the respective segments of the sealing strip may comprise the step of providing the respective segment at one of the two side edge sections. For example, the step of providing the respective segment(s) of the sealing strip may comprise the step of heat sealing the respective segment(s) at one of the two side edge sections. Preferably, the step of providing the respective segment(s) at one of the side edge sections may be completed (after the step of providing the flat sheet and) before the step of forming the flat sheet into the tube.

With anyone of the aforementioned configurations, it can be ensured that the sealing strip (and the respective segments) can be placed accurately in the desired position of the triple point section so that the sealing reliability of the packaging can be improved.

According to a preferred embodiment, at least part of the sealing strip (or preferably at least part of the first segment and/or of the second segment) may be provided so that each of the respective segments is sandwiched between the two side edge sections at the overlapping section. Preferably, the respective segments may be sandwiched along the entire length of the overlapping section.

Thereby, it can be ensured that the sealing strip or the respective segment is always placed at a triple point section because the overlapping section defines part of the triple point section. Thereby, the integrity and quality of the sealing of the packaging at the triple point section can be improved.

According to a further preferred embodiment, the step of providing the respective segment may comprise the step of arranging the respective segment, preferably the sealing strip, at the overlapping section between the two side edge sections so that the respective segment(s) may extend (in) to the respective triple point section, preferably after the step of heat sealing the longitudinal sealing joint.

Thereby, it can be ensured that a desired amount of additional sealing material is always provided at a triple point section. In particular, it is possible to adjust the amount of sealing material provided at the triple point section by adapting the width of the sealing strip, which can be used to control the size of the portion of the sealing strip (or segment) that extends into the triple point section.

According to a preferred embodiment, the step of providing the sealing strip may comprise the step of unrolling a strip of a film material from a film reel.

Thereby, the manufacturing process can be simplified and the production speed of the packaging can be improved since the sealing strip can be rolled off the film reel with the same speed that is used to process the sheet material.

According to a further preferred embodiment, the first segment and the second segment may be sections of the sealing strip or may be separate strips of the sealing strip.

By providing the segments as portions of the sealing strip, manufacturing processes can be simplified and production speed can be increased. In comparison, by providing the segments as separate strips of the sealing strip, material consumption for producing the packaging can be lowered and the ecological impact of the packaging can be reduced.

According to a preferred embodiment, the sealing strip may be made of a food grade material. The sealing strip is heat-sealable. Preferably, the sealing strip may comprise or may be made of a solid polymer, such as polypropylene (PP), polyethylene, low-density polyethylene (LDPE), or metallocene linear low density polyethylene (LLDPE). Preferably, the sealing strip may be a blown film or a cast film.

Thereby, packaging for a large variety of different food applications can be produced with the method of the invention as the material of the sealing strip can be tailored to the individual application. For example, low-density polyethylene has a good resistance to breakage, is flexible, elastic and can be supplied as a thin film. Moreover, the above listed examples for sealing strip materials can be provided from sustainable sources, may be compostable and/or may be biodegradable so that the ecological impact of the so produced packaging can be reduced.

According to a further preferred embodiment, the sealing strip may comprise a thickness in the range of 10 micrometres to 100 micrometres, preferably between 20 micrometres to 80 micrometres, more preferred between 40 micrometres to 60 micrometres. Most preferred, the thickness may be 40 micrometres. Alternatively or additionally, the sealing strip may comprise a width in the range of 1 mm to 100 mm, preferably between 4 mm and 50 mm, most preferred between 5 mm and 10 mm.

By defining the thickness of the sealing strip, the amount of additional sealing material, which is provided by the segment(s) or by the sealing strip at the triple point section, can be accurately defined. Thereby, the production process of the packaging can be controlled and packaging of consistent sealing quality can be ensured. Furthermore, by providing the sealing strip within the above cited width range it is possible to ensure tight sealing of the packaging while maintaining the recyclability of the packaging.

According to a preferred embodiment, the step of providing the flat sheet may comprise the step of unrolling a longitudinal flat sheet material from a sheet reel. Alternatively or additionally, the flat sheet material may be a recyclable (biodegradable and/or compostable) polymer (e.g. a plastic film), paper or laminate. More preferred, the sheet material may be flexible and/or foldable. The flat sheet material may comprise a laminated and/or multilayered structure. Preferably, the laminated and/or multilayered structure may comprise a base layer. For example, the base layer may be made of a paper material (e.g. having a grammage of up to 100 g/m²) or a recyclable plastic material (e.g. polypropylene). In addition, the laminated and/or multilayered structure may preferably comprise a sealant layer. For example, the flat sheet material may be a coated paper. For instance, the sealant layer of the coated paper may be too thin to provide a tight sealing upon heat sealing. A further example may be to use a thin (e.g. thickness of 18 micrometres) layer of (metallized and/or oriented) polypropylene for the base layer and a comparatively thicker layer of polyethylene (e.g. thickness of 50 micrometres) for the sealant layer.

Preferably, the flat sheet material may comprise a sealant layer of a thickness that is sufficient for providing material bonding between the surfaces to be sealed but that is insufficient for providing (gas or vacuum) tight sealing joints.

According to a further preferred embodiment, the sealant layer may be made of the same material as the sealing strip. Alternatively or additionally, the sealant layer may comprise polypropylene, and/or polyethylene. However, it is also conceivable to provide the flat sheet material as a single (mono-) layer. Preferably, the respective segments may be provided on the sealant layer.

Therein, the expression “laminated/layered structure” may be understood, for example, as a structure comprising different parts that are arranged in plies, slats, tiers or as strata. Therein, it is possible to provide the flat sheet with an arbitrary number of layers that each can provide a desired functionality, such as, for example, a layer for forming a (moisture/oxygen) barrier, and/or for providing a sealant for heat sealing (such as, for example, said sealant layer). Thereby, the material characteristics of the flat sheet can be tailored to the needs of the respective application. In addition, it is possible to use alternative materials for the flat sheet material of the packaging that comprise a reduced amount of sealing materials and thus, reduce the environmental impact of the packaging without having to compromise on the tightness of the sealing joints.

A further aspect of the present invention relates to a recyclable packaging that encloses a substance and that is made of a flat sheet.

Therein, the expression “enclose” may be understood, for example, as surrounding, covering, wrapping and/or encasing the substance, preferably in a sealing manner.

The flat sheet comprises two opposite side edge sections and is made of a recyclable sheet material. The packaging comprises a longitudinal sealing joint—preferably made or formed by heat sealing—along an overlapping section, at which the two opposite side edge sections overlap each other when the flat sheet is folded to form the flat sheet into a tube. The packaging thus preferably comprises the longitudinal sealing joint being made or formed by heat sealing the tube along the overlapping section. The packaging comprises a first traverse sealing joint, preferably made by heat sealing, which first traverse sealing joint extends across the longitudinal sealing joint to close the tube at a first tube end. The packaging thus preferably comprises the first traverse sealing joint being made or formed by heat sealing the tube across the longitudinal sealing joint to close the tube at the first tube end. The packaging comprises a second traverse sealing joint, preferably made by heat sealing, the second traverse sealing joint extending across the longitudinal sealing joint to close the tube at a second tube end opposite to the first tube end with respect to the enclosed substance. The packaging thus preferably comprises the second traverse sealing joint being made or formed by heat sealing the tube across the longitudinal sealing joint to close the tube at the second tube end. The packaging also comprises a sealing strip that is heat-sealable. The packaging is provided such that a heat-sealed first segment of the sealing strip is provided at a first triple point section to seal the first triple point section, and such that a heat-sealed second segment of the sealing strip is provided at a second triple point section to seal the second triple point section. Therein, at the first triple point section, the longitudinal sealing joint and the first traverse sealing joint intersect. At the second triple point section, the longitudinal sealing joint and the second traverse sealing joint intersect.

Thereby, a packaging can be provided that encloses the substance with reliable sealing at the triple point sections and that can be recycled easily and efficiently after being used.

According to a preferred embodiment, at least part of the sealing strip may be sandwiched between the two side edge sections at the overlapping section and preferably (additionally) along the entire length of the overlapping section. Alternatively or additionally, at least part of the heat-sealed first segment may be sandwiched between the two side edge sections at the respective overlapping section and preferably along the entire length of the overlapping section. Alternatively or additionally, at least part of the heat-sealed second segment may be sandwiched between the two side edge sections at the respective overlapping section and preferably along the entire length of the overlapping section.

Thereby, it can be ensured that the triple point area is reliably and consistently sealed from the outside because the above described arrangement of the sealing strip ensures that sealing material is reliably available at those parts of the packaging (e.g. sealing joints) that undergo heat sealing and that are critical for the integrity of the sealing.

According to a further preferred embodiment, the sealing strip, preferably at least one of the respective heat-sealed segments, is/are arranged at the overlapping section between the two side edge sections so that the respective heat-sealed segment extends (in) to the respective triple point section.

Thereby, it can be ensured that a desired amount of additional sealing material is always provided at a triple point section. In particular, it is possible to adjust the amount of sealing material provided at the triple point section by adapting the width of the sealing strip, which can be used to control the size of the portion of the sealing strip (or segment) that extends into the triple point section.

According to a further preferred embodiment, the heat-sealed first and second segments may be sections of a continuous strip so that the sealing strip may extend continuously along the longitudinal sealing joint.

Thereby, it can be ensured that additional sealing material is not only provided at the triple point sections but along the entire length of the longitudinal sealing joint. Thereby, besides improving the sealing strength and integrity of the sealing at the triple point sections, the sealing strength and integrity of the entire longitudinal sealing joint can be improved also.

According to a preferred embodiment, the packaging may be a multi-serve pack like a stand-up pouch, a pillow pouch, or a gusseted bag. Alternatively, the packaging may be a single serve pack like a stick pack.

Therein, it was found that in particular the above mentioned types of packaging benefit from the configuration defined by the invention and, thus, can be provided with sealing of high quality and reliability.

According to a further preferred embodiment, the flat sheet may comprise a laminated structure or a multilayered structure comprising a base layer and/or a sealant layer. For example, the base layer may be made of a paper material or a recyclable plastic material. The sealant layer may be provided as a coating or a sealing film (e.g. a laminate) that may act as a sealant for the sealing joints during heat sealing. Preferably, the sealant layer may be provided on at least one of the two opposite side surfaces of the flat sheet. The heat-sealed first and second segments may be provided on the sealant layer.

Thereby, it is possible to further support the sealing effects derived from providing the segments of the sealing strip because the strength of material bonding can be increased by the segments of the sealing strip binding opposite sealant layers of the tube material.

According to a preferred embodiment, the side edge sections may be facing each other with the same side of the flat sheet at the overlapping section. Moreover, the overlapping section may be formed such that it protrudes from the packaging. Alternatively, the overlapping section may be formed such that both side edge sections or the overlapping section may be positioned at an outer side of the packaging.

Thereby, the sealing strength and integrity of the longitudinal sealing joint can be improved as the sealing can be performed directly and under the application of pressure. Thus, the overall shelf-life of a so configured packaging can be increased.

Naturally, the packaging may comprise all features or characteristics described above for the method according to the first aspect of the invention. For reasons of brevity, explicit reiteration of these features and effects is omitted at this juncture.

A further aspect of the present invention relates to a machine for producing a recyclable packaging for enclosing a substance as described above. The machine comprises a first feeding system for supplying a flat sheet that is made of a sheet material and that has two opposite side edge sections. The machine further comprises a folding section for folding the supplied flat sheet so that the two opposite side edge sections overlap each other at an overlapping section to form the flat sheet into a tube. The machine comprises also a first heat sealing section for heat sealing the tube along the overlapping section to form a longitudinal sealing joint, and a second heat sealing section for heat sealing the tube across the longitudinal sealing joint to close the tube with a first traverse sealing joint at a first tube end. The machine further comprises a filling section for filling the tube with a substance to be packed. Moreover, the machine comprises a third heat sealing section for heat sealing the tube across the longitudinal sealing joint to close the tube with a second traverse sealing joint at a second tube end opposite to the first tube end with respect to the substance to be packed so as to form the packaging enclosing said substance. The machine further comprises a second feeding system. The second feeding system is for supplying a sealing strip such that a first segment of the sealing strip is provided at a first triple point section so that the first segment seals the first triple point section upon the heat sealing of the tube at the second heat sealing section to form the first traverse sealing joint. Therein, at the first triple point section, the longitudinal sealing joint and the first traverse sealing joint will intersect. The second feeding system is further provided for supplying a sealing strip such that a second segment of the sealing strip is provided at a second triple point section so that the second segment seals the second triple point section upon the heat sealing of the tube at the third heat sealing section to form the second traverse sealing joint. Therein, at the second triple point section, the longitudinal sealing joint and the second traverse sealing joint will intersect.

Thereby, a machine can be provided that produces a packaging that can (hermetically) sealingly encase a substance to be packed and that can be recycled easily after being used. In particular, the machine is capable of providing a sealing strip at the triple point sections so that the quality and reliability of the sealing can be ensured with consistency.

According to a preferred embodiment, the second feeding system may be configured to supply at least part of the sealing strip at the respective triple point section(s). Preferably, the second feeding system may be configured to provide at least part of at least one of the respective segments at the respective triple point section(s) so as to be sandwiched between the two side edge sections at the overlapping section, respectively, and preferably along the entire length of the overlapping section.

Thereby, it can be ensured that the triple point sections are reliably sealed without having to provide complex positioning equipment for placing the segments in the tube.

According to further a preferred embodiment, the second feeding system may comprise a film reel feeding system for providing and arranging the sealing strip at the folding section between the two side edge sections and at the overlapping section. Furthermore, the first feeding system may comprise a sheet reel feeding system for unrolling a longitudinal flat sheet material from a sheet reel to supply the flat sheet.

Thereby, it is possible to provide the sealing strip in a manner that facilitates efficient and reliable provision of the sealing strip into the tube and on the desired places while being compliant for a continuous production of packaging made from a sheet material.

According to a preferred embodiment, the second and third heat sealing sections may be integral or identical. Preferably, the first heat sealing section may comprise a preferably movable sealing part, such as a sealing bar. The sealing part may be configured to cooperate with a preferably fixed counterpart. The counterpart may be provided by a portion of the folding section or of the filling section for forming the longitudinal sealing joint. For example, the counterpart may be a folding tube that may be part of the folding section.

Thereby, the number of components on the machine can be reduced and it can be ensured that the traverse sealing joints are provided in an identical manner.

Preferably, the machine may be configured (adapted) to complete any or all of the above described steps of the method of the first aspect of the invention.

### 4. BRIEF DESCRIPTION OF DRAWINGS

Further features, advantages and objects of the invention will become apparent for the skilled person when reading the following detailed description of embodiments of the invention and when taking in conjunction with the drawings of the enclosed figures. In case numerals have been omitted from a figure, for example for reasons of clarity, the corresponding features may still be present in the figure.

FIG. 1 shows a schematic top view of a pillow packaging of the prior art.

FIG. 2 shows a schematic sectional view of the prior art packaging of FIG. 1 along the lines II-II.

FIG. 3 shows a photography of a microtome cut of a prior art packaging along the lines II-II indicated in FIG. 1.

FIGS. 4A to 4E show different schematic perspective views (FIGS. 4A to 4D) and a sectional view (FIG. 4E along the lines IV-IV indicated in FIG. 4A) of an embodiment of a method and of a machine for producing a recyclable packaging according to the present invention.

FIGS. 5A to 5E show different schematic perspective views (FIGS. 5A to 5D) and a sectional view (FIG. 5E along the lines V-V indicated in FIG. 5A) of a further embodiment of a method and of a machine for producing a recyclable packaging according to the present invention.

FIGS. 6A and 6B show a schematic sectional view and a further photography of a sectional view of a prior art packaging along the lines II-II of FIG. 1.

FIGS. 7A and 7B show a schematic sectional view and a photography of a microtome cut along the lines VII-VII of FIGS. 8 and 9 for a packaging according to present invention.

FIGS. 8 and 9 show schematic top views of different embodiments of a packaging according to the present invention.

### 5. DETAILED DESCRIPTION

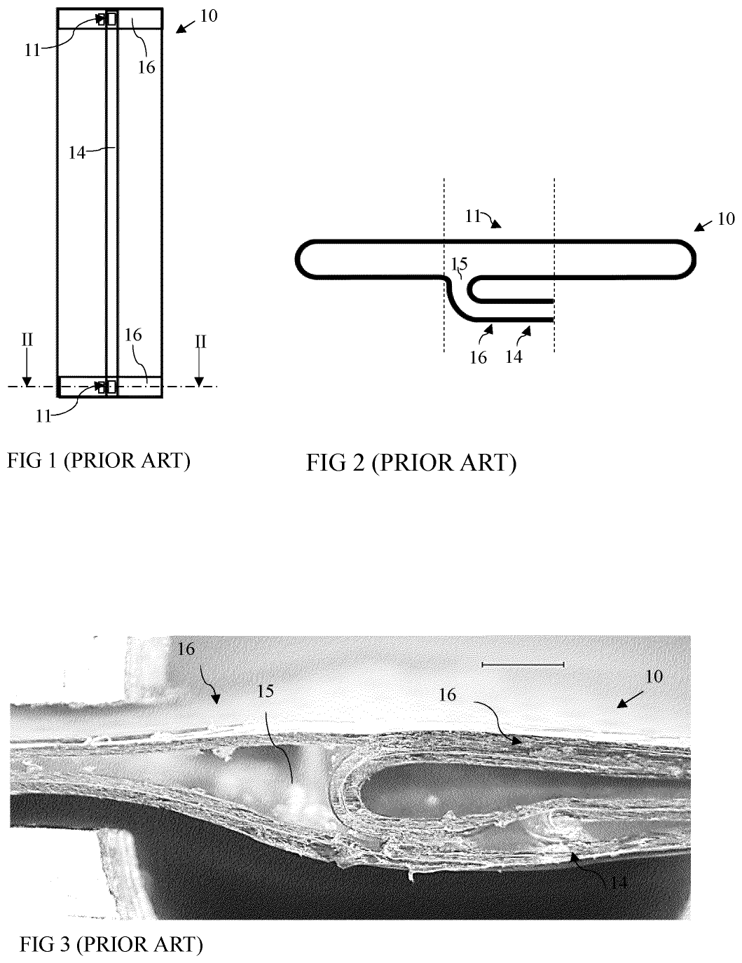

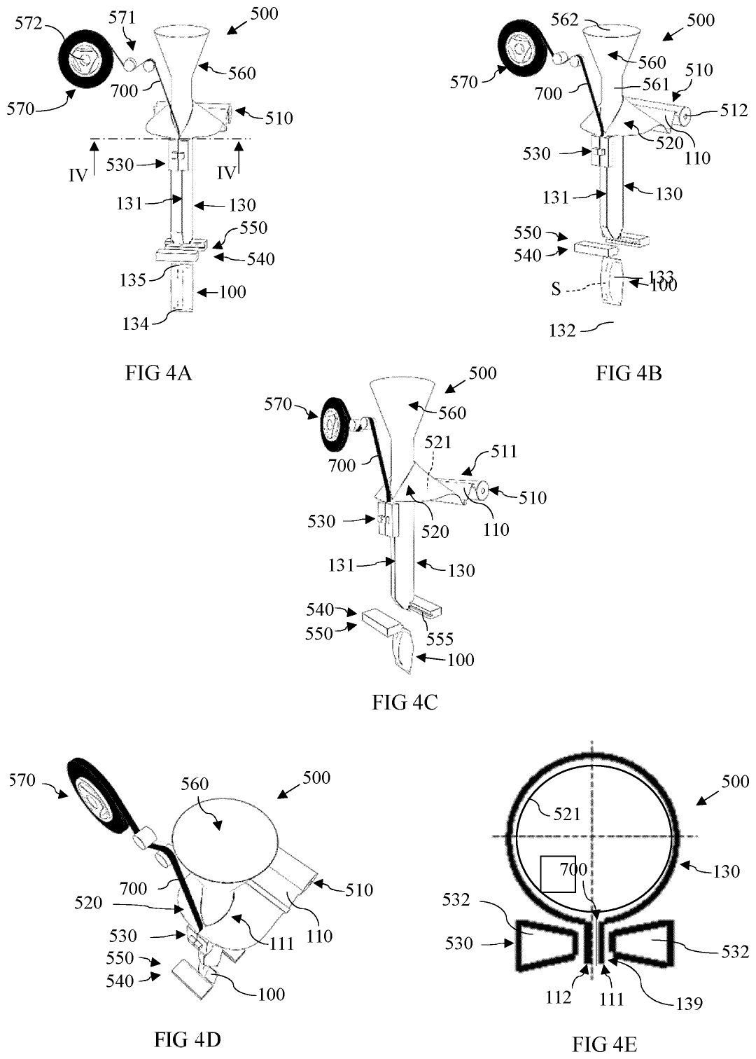

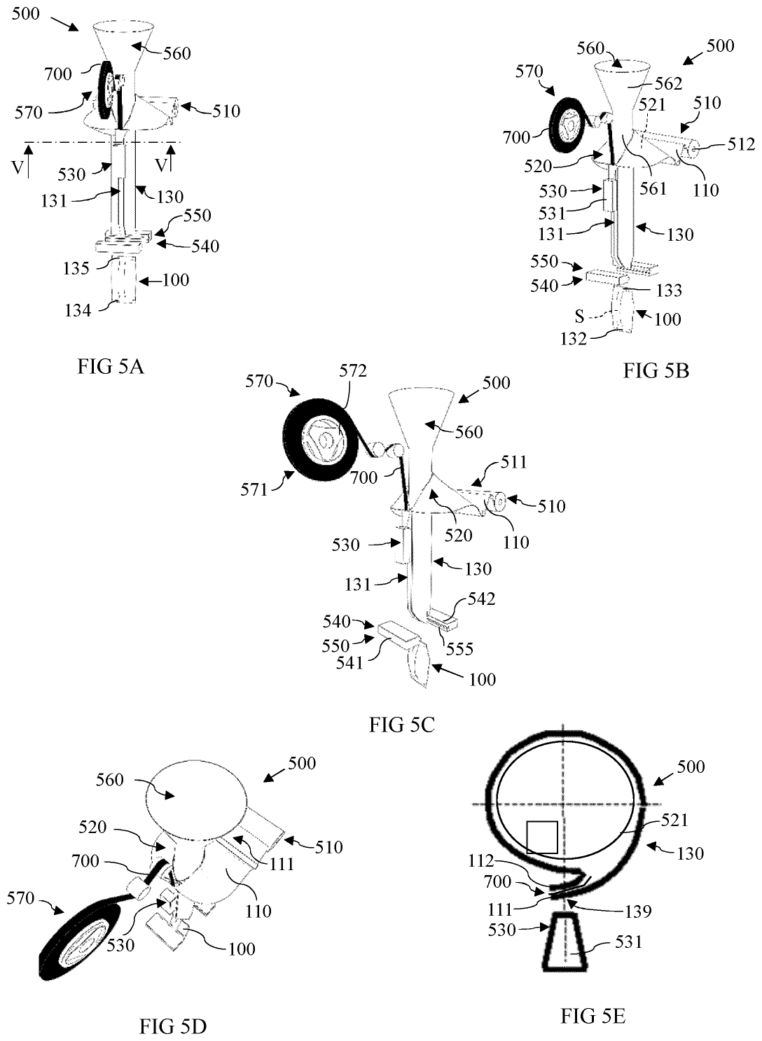

The Figures show different views and aspects of the invention. FIGS. 4 and 5, for example, illustrate some of the steps of a method for producing a recyclable packaging according to one aspect of the invention. In addition, FIGS. 4 and 5 show aspects of a machine 500 for producing a recyclable packaging 100 according to a further aspect of the invention. FIGS. 7 to 9 illustrate aspects of the packaging 100 according to another aspect of the invention. For comparison and clarification purposes, FIGS. 1 to 3, and 6 highlight characteristics of prior art packaging.

The method according to the invention relates to producing a recyclable packaging, such as the packaging 100 described in detail further below, for enclosing a substance S. For example, the substance S may be a food product, such as a powdered (food) product or dehydrated edible substances, such as (sensitive) infant formula, infant cereals, cereals, powdered coffee, soluble coffee, or dairy products, e.g. coffee creamers. However, it is also conceivable to package spice mixtures or spice pastes or gels, and/or a pharmaceutical or medical product, as the substance S. However, this is not a complete enumeration and other products can be packaged as the substance S.

The method comprises the step of providing a flat sheet 110. FIGS. 4A to 4D as well as 5A to 5D illustrate this step exemplarily. Therein, it is exemplarily illustrated that the flat sheet 110 may be provided by unrolling a longitudinal flat sheet material from a sheet reel 512. For example, the flat sheet 110 may extend lengthwise along a longitudinal axis and may be unrolled in a direction transversely to said longitudinal axis. Preferably, the longitudinal axis of the flat sheet material may be parallel to the rotational axis of the sheet reel 512.

The flat sheet 110 may have any shape or form. For example, the flat sheet 110 may have a (substantially) quadratic or rectangular form, such as FIGS. 4, 5, and 7 to 9 illustrate exemplarily. However, these are only examples and not a complete enumeration of possible forms or shapes. Preferably, the flat sheet 110 may have two opposite (continuous) side surfaces, which preferably may define the thickness of the flat sheet 110 between them. Preferably, the thickness of the flat sheet 110 may be small in relation to its length and width. For example, the thickness of the flat sheet 110 may be in the range between 40 micrometres and 140 micrometres.

The flat sheet 110 has two opposite side edge sections 111, 112. This is exemplarily indicated in FIGS. 4D, 4E, 5D, 5E and 7A. Preferably, the side edge sections 111, 112 may be sections of the flat sheet 110 extending from opposite lateral edges of the flat sheet 110 towards each other. For instance, it is conceivable that the two side edge sections 111, 112 together may form the complete surface of one of the side surfaces of the flat sheet 110.

The flat sheet 110 is made of a material (i.e. the flat sheet material) that is recyclable.

For example, the flat sheet 110 may be made of or may comprise a paper material, such as a paper material having a grammage of up to 100 g/m². For example, the flat sheet 110 may be made of a material that may comprise paper (e.g. exclusively or at least primarily made of cellulose fibres, such as cellulose fibres derived from wood, grass, and/or bamboo) as well as further (arbitrary) components that may or may not be recyclable or biodegradable. Therein, the further components, which, for example, may be a plastic coating or other polymer content, would be limited to a quantity of up to about 5% of the total weight of the (entire) flat sheet material (so to render the flat sheet material still recyclable). While the further components may be provided as layers, laminates on the paper material, it is also conceivable that the further components may be mixed or blended into the paper material itself. However, these are only examples and do not represent a complete enumeration. Examples for suitable recyclable paper material may be machine glazed paper or metallized paper. For example, the machine glazed paper may be a paper without any coating and one side thereof may have a smooth surface while the side opposite thereto may have a rough surface. Metallized paper may be a paper coated with a layer of metal, such as aluminium, whereby preferably the coating may be applied by lamination or vacuum metallization.

Alternatively or additionally, a recyclable plastic based laminate or a recyclable plastic material, such as (metallized oriented or biaxial oriented) polypropylene or polyethylene, may be used as material for the flat sheet 110.

Alternatively or additionally, the flat sheet 110 may be made of a flat sheet material that may comprise a laminated or multilayered structure. The laminated or multilayered structure may comprise a base layer that may be made of the aforementioned paper material or recyclable plastic material. In addition, the laminated or multilayered structure may comprise a sealant layer. For example, polypropylene, polyethylene, a polyolefin dispersion or an acrylic coating may be used as a sealant. The sealant layer may change its physical state or binding characteristics under heat, and/or pressure. Preferably, the sealant layer may be provided on at least one of the two opposite side surfaces of the flat sheet 110. The sealant layer may be a coating that acts as a sealant in a heat sealing process. It is also conceivable that the flat sheet 110 may be made of a material that may comprise additional layers, such as an oxygen barrier layer, which preferably may be of a recyclable, biodegradable and/or compostable material. Alternatively or additionally, the flat sheet 110 may be made of a flexible or a rigid material in relation to usual (manual) handling forces of the packaging.

For instance, if a paper material is used as the base layer, the thickness of the sealant layer may be in a range between 5 micrometres and 10 micrometres. For example, this may be the case if a coated paper is used as the flat sheet material. Sealing temperatures may be between 100 degree Celsius and 220 degree Celsius.

Alternatively or additionally, if, for instance, a recyclable (and sustainable) plastic based laminate (e.g. a sealing film) may be used as the base layer, the thickness of the sealant layer may be in a range between 20 micrometres and 90 micrometres. Sealing temperature in this case may be between 110 degree Celsius and 180 degree Celsius.

The method comprises further the step of forming the flat sheet 110 into a tube 130 by folding the flat sheet 110 so that the two side edge sections 111, 112 at least partially overlap each other at an overlapping section 139. This step is exemplarily illustrated in FIGS. 4A to 4D and 5A to 5D. For example, a folding tube 521 may be used to perform the step of folding the flat sheet 110 into the tube 130. Preferably, the tube 130 may have a circular or elliptical cross-section, such as exemplarily shown in FIGS. 4, 5 and 7A. At the overlapping section 139, the side edge sections 111, 112 may face each other with the same side of the flat sheet 110. Thus, the two side edge sections 111, 112 may be folded such that they come to rest onto each other with the same side of the flat sheet 110. This is exemplarily shown in FIGS. 4, 5 and 6 to 9. Preferably, the two side edge sections 111, 112 may be placed onto each other such that their respective side edges 111, 112 come into abutment with each other.

The method comprises further the step of heat sealing the tube 130 along the overlapping section 139 to form a longitudinal sealing joint 131. This is exemplarily illustrated in FIGS. 4A to 4E as well as FIGS. 5A to 5E. The step of heat sealing may be performed by arranging and compressing the overlapping section 139 between a sealing part, such as a sealing bar 531, and a corresponding counterpart. For example, the counterpart may be the forming tube 521. This is exemplarily illustrated in FIGS. 5A to 5E, where the provision of the longitudinal sealing joint 131 as a fin seal is shown. It is also conceivable to perform heat sealing by arranging the overlapping section 139 between two sealing bars 532, 532 (i.e. the counterpart being another sealing bar) as exemplarily illustrated in FIGS. 4A to 4E, where the provision of the longitudinal sealing joint 131 as an (offset) fin seal is shown. Preferably, the longitudinal sealing joint 131 may at least partially, preferably fully, extend between opposite ends of the tube 130. For this, the heat sealing step may additionally provide the step of moving the tube 130 relatively to the sealing part and the corresponding counterpart. The tube 130 and/or the overlapping section 139 may be moved along the longitudinal axis of the tube 130.

The method comprises further the step of heat sealing the tube 130 across the longitudinal sealing joint 131 to close the tube 130 with a first traverse sealing joint 134 at a first tube end 132. This is exemplarily illustrated in FIGS. 4A to 4D and FIGS. 5A to 5D. Preferably, the first tube end 132 may be defined by the first traverse sealing joint 134. Alternatively or additionally, the tube 130 may be provided with a tube end, namely the first tube end 132, by or after providing the first traverse sealing joint 134. The step of heat sealing the first traverse sealing joint 134 may be performed by two sealing jaws 541, 542 that may be arranged opposite to each other. This is exemplarily illustrated in FIGS. 4A to 4D as well as FIGS. 5A to 5D. The two sealing jaws 541, 542 may be (linearly and/or rotationally) movable to each other. The heat sealing jaws 541, 542 may be moved between a sealing state and a release state. In the sealing state, the tube 130 may be pressed between the two sealing jaws 541, 542 to apply a binding force (e.g. between 500 N to 8000 N), and/or heat (temperature between 100 degree Celsius to 250 degree Celsius) to the tube 130 for a certain amount of time (e.g. between 0.1 to 2 seconds). In the release state, the tube 130 may be movable between (released from) the two sealing jaws 541, 542. Generally, it is conceivable that both or only one of the sealing jaws 541, 542 may be movable.

The method comprises the step of filling the tube 130 with a substance S to be packed. For example, the step of filling the tube 130 may comprise the step of providing a filling tube 561 having a funnel portion 562 on the top and pouring a quantity of the substance S to be packed into the filling tube 561. Preferably, the filling tube 561 may extend into the tube 130 and end above the first tube end 132. This is exemplarily shown in FIGS. 4B and 5B but also illustrated in the other illustrations of FIGS. 4 and 5. Preferably, the step of filling the tube 130 may be completed after the step of heat sealing the first traverse sealing joint 134 and/or the step of heat sealing the longitudinal sealing joint 131.

The method comprises further the step of heat sealing the tube 130 across the longitudinal sealing joint 131 to close the tube 130 with a second traverse sealing joint 135 at a second tube end 133 so as to form the packaging 100 enclosing the substance S. The second tube end 133 is opposite to the first tube end 132 with respect to the substance S to be packed. Preferably, the second tube end 133 may be defined by the second traverse sealing joint 135. Alternatively or additionally, the tube 130 may be provided with an additional tube end, namely the second tube end 133, by or after providing the first traverse sealing joint 135. It is conceivable that the step of heat sealing the second traverse sealing joint 135 may be performed by the two sealing jaws 541, 542 in the same way as described above for the first traverse sealing joint 134. Alternatively, it is also conceivable that the step of heat sealing the second traverse sealing joint 134 may be performed with different heat sealing means, such as a separate set of sealing bars. Preferably, the step of heat sealing the second traverse sealing joint 135 may be performed (immediately) after filling the tube 130 with the substance S. Thereby, the packaging 100 is formed such that it (entirely) encloses the substance S.

The method comprises further the step of providing a heat-sealable sealing strip 700. This is exemplarily illustrated in FIGS. 4A to 4E and 5A to 5E, where, for instance, the step of providing the sealing strip 700 is illustrated as comprising the step of unrolling a strip of a film material from a film reel 572. For example, the film reel 572 may be arranged with respect to the tube 130 such that, during unrolling, one of the side surfaces of the sealing strip 700 may extend parallel to the longitudinal axis of the tube 130 (e.g. illustrated in FIG. 5). The sealing strip 700 may be a continuous band of a solid film material, such as a blown film. For example, the sealing strip 700 may be made of a food grade material. Alternatively or additionally, the sealing strip 700 may comprise or may be made of a solid polymer, such as polypropylene, polyethylene, low-density polyethylene, or metallocene linear low density polyethylene. Preferably, the sealing strip 700 may be made of the same material as the sealant layer of the flat sheet 110. The sealing strip 700 may have two opposite side surfaces that define the thickness of the sealing strip 700. For example, the sealing strip 700 may comprise a thickness in the range of 10 micrometres to 100 micrometres, preferably between 20 micrometres to 80 micrometres, more preferred between 40 micrometres to 60 micrometres. Most preferred, the thickness may be preferably around 40 micrometres. Moreover, the sealing strip 700 may comprise a width in the range of 1 mm to 100 mm, preferably between 4 mm and 50 mm, most preferred between 5 mm and 10 mm. Further, the sealing strip 700 may be made of a material that may melt by applying pressure, and/or temperatures in the range of 100 degree Celsius to 250 degree Celsius.

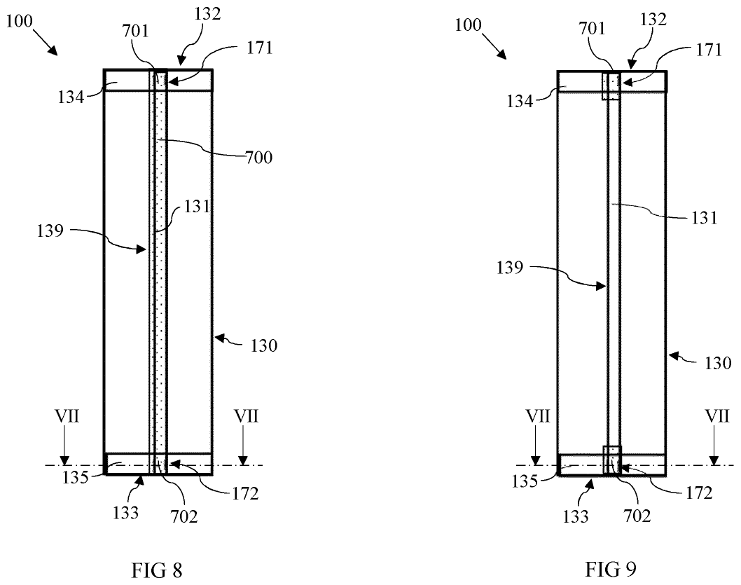

The heat-sealable strip 700 is provided such that a first segment 701 of the sealing strip 700 is provided at a first triple point section 171, at which the longitudinal sealing joint 131 and the first traverse sealing joint 134 intersect. In addition, the heat-sealable strip 700 is provided such that a second segment 702 of the sealing strip 700 is provided at a second triple point section 172, at which the longitudinal sealing joint 131 and the second traverse sealing joint 135 intersect. FIGS. 4A to 4E as well as FIGS. 5A to 5E show possible implementations of this step. FIGS. 8 and 9 show their positions exemplarily. For instance, the sealing strip 700 may be inserted in parallel with the longitudinal sealing joint 131 to implement these steps.

For example, it can be taken from the exemplary illustrations of FIGS. 4 and 5 that the heat-sealable strip 700 may be guided to the tube 130 so that at least part of the sealing strip 700 is sandwiched between the two side edge sections 111, 112 at the overlapping section 139. Therein, the respective segments 701, 702 of the sealing strip 700 may be provided during the step of forming the flat sheet 110 into the tube 130. Alternatively or additionally, the respective segments 701, 702 of the sealing strip 700 may be provided before or during the step of heat sealing the longitudinal sealing joint 131. However, it is also conceivable that (one or both of) the respective segments 701, 702 may be provided (for example by heat sealing) at one of the two side edge sections 111, 112 before the step of forming the flat sheet 110 into the tube 130 (not illustrated).

Preferably, at least part of the sealing strip 700, of the first segment 701 and/or of the second segment 702 may be provided so that each of the respective segments 701, 702 is sandwiched between the two side edge sections 111, 112 at the overlapping section 139. Therein, it may be additionally preferred if the respective part(s) of the sealing strip 700 may be sandwiched along the entire length of the overlapping section 139. This is exemplarily illustrated in FIG. 8. The first segment 701 and the second segment 702 may be sections of the sealing strip 700, for example. FIGS. 4, 5 and 8 illustrate this exemplarily. However, it is also conceivable to provide the first segment 701 and the second segment 702 as separate strips of the sealing strip 700, as exemplarily illustrated in FIG. 9. Preferably, the sealing strip 700 and/or the respective segments 701, 702 may be provided on the sealant layer of the sheet material forming the tube 130.

In the step of providing one or more of the segments 701, 702, the respective segment 701, 702 (or a part of (or the entirety of) the sealing strip 700), may be arranged at the overlapping section 139 between the two side edge sections 111, 112 in a way that facilitates that said segment 701, 702 extends at least to the respective triple point section 171, 172. Such step may be performed preferably after the step of heat sealing the longitudinal sealing joint 131. FIGS. 4, 5, and 7 to 9 show implementations of this step exemplarily. In particular, FIG. 7A illustrates exemplarily how the respective segment 701 can be arranged between the side edge sections 111, 112 so that it extends into the respective triple point section 171, 172.

According to the method, it is ensured that the respective segments 701, 702 of the sealing strip 700 are provided at the respective triple point sections 171, 172 so that the respective segments 701, 702 seal the respective triple point section 171, 172 when the respective tube end 132, 133 is heat sealed during the process of heat sealing the respective traverse sealing joint 134, 135. FIG. 7A shows an exemplary arrangement.

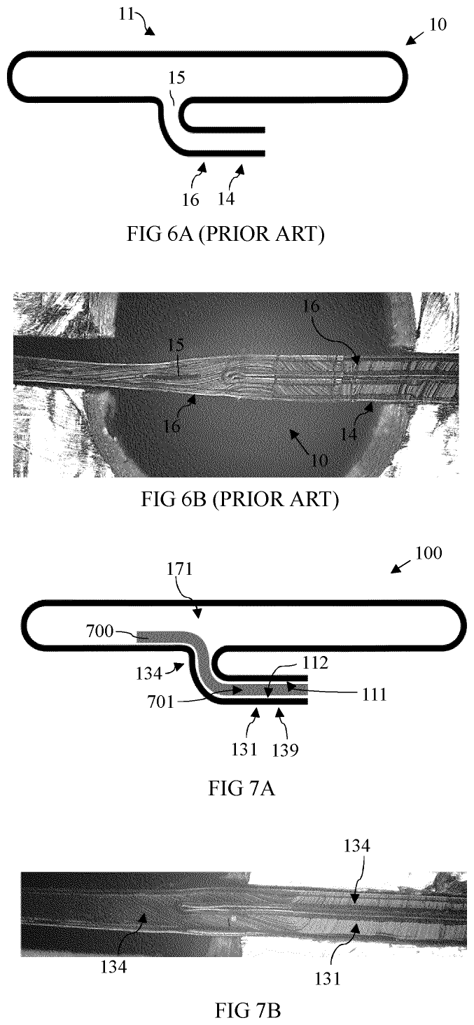

Thereby, it can be ensured that enough sealing material exists reliably in the triple point sections 171, 172 when providing the traverse sealing joints 134, 135. FIG. 7B, which shows a photography of a microtome cut at one of the triple point sections 171, 172, illustrates that the respective triple point section 171, 172 is completely filled with sealing material. In comparison, in FIG. 6A the configuration of a packaging 10 known from the prior art at the triple point area 11 is illustrated. A microtome cut at this triple point area 11 shows, as exemplarily illustrated in the photography of FIG. 6B, that a gap 15 exists that forms a passage between the outside and the interior of the packaging 10.

Naturally, it is also conceivable that the method may provide one or more steps for providing more than the two segments 701, 702, for example, in case more than the described two triple point sections 171, 172 would exist.

As a result of completing steps of the method, a recyclable packaging is received.

A further aspect of the present invention relates to the recyclable packaging 100. The packaging 100 may be produced with the above described method. FIGS. 4, 5, and 7 to 9 show the packaging 100 exemplarily. For example, the packaging 100 may be a multi-serve pack, such as a stand-up pouch, a pillow pouch, or a gusseted bag. However, it is also conceivable that the packaging 100 may be a single serve pack, such as a stick pack. The packaging 100 encloses a substance, such as the aforementioned substance S. This is exemplarily indicated by broken lines in FIGS. 4B and 5B. Preferably, the packaging 100 may be configured to hermetically seal the substance S.

The packaging 100 is made of a flat sheet with two opposite side edge sections and made of a recyclable material, such as the above described flat sheet 110 with the side edge sections 111, 112 and may be made of the aforementioned described flat sheet material.

The packaging 100 comprises a longitudinal sealing joint like the longitudinal sealing joint 131, which runs along the overlapping section 139, at which the two opposite side edge sections 111, 112 overlap each other when the flat sheet 110 is folded into the shape of a tube 130. This is exemplarily illustrated in FIGS. 4, 5, and 7 to 9. The longitudinal sealing joint 131 is preferably made or formed by heat sealing the tube 130 along the overlapping section 139. The longitudinal sealing joint 131 may extend along the overlapping section 139 in various way. For example, the longitudinal sealing joint 131 may extend obliquely between opposite ends of the packaging 100. This may be subject to the shape of the flat sheet 110 (e.g. the flat sheet 110 having a trapezoid base form).

Generally, the side edge sections 111, 112 may be facing each other with the same side of the flat sheet 110 at the overlapping section 139. Moreover, the overlapping section 139 may be formed such that it protrudes from the packaging 100. The overlapping section 139 may be formed such that both side edge sections 111, 112 or the overlapping section 139 are positioned at an outer side of the packaging 100. FIG. 7A shows an example.

The packaging 100 comprises a first traverse sealing joint like the above described first traverse sealing joint 134, which extends across the longitudinal sealing joint 131 to close the tube 130 at the first tube end 132. The first traverse sealing joint 134 is preferably made or formed by heat sealing the tube 130 across the longitudinal sealing joint 131 to close the tube 130 at the first tube end 132. The packaging comprises further a second traverse sealing joint like the above described second traverse sealing joint 135, which extends across the longitudinal sealing joint 131 to close the tube 130 at the second tube end 133, which is opposite to the first tube end 132 with respect to the enclosed substance S. The second traverse sealing joint 135 is preferably made or formed by heat sealing the tube 130 across the longitudinal sealing joint 131 to close the tube 130 at the second tube end 133. This is exemplarily shown in FIGS. 4, 5 8 and 9. Unlike exemplarily shown in these Figures, the first traverse sealing joint 134 and/or the second traverse sealing joint 135 may extend also in an oblique or curved manner to form the respective tube ends 132, 133.

The packaging 100 comprises further a heat-sealable sealing strip, such as the above described sealing strip 700 and preferably may be made of similar or the same materials as described in detail above. The sealing strip 700 is provided such that a heat-sealed first segment of this sealing strip is provided at a first triple point section, such as the above described heat-sealed first segment 701, which is provided at the first triple point section 171, at which the longitudinal sealing joint 131 and the first traverse sealing joint 134 intersect, to seal the first triple point section 171. The sealing strip 700 is also provided such that a heat-sealed second segment of this sealing strip is provided at a second triple point section, such as the above described heat-sealed second segment 702, which is provided at the second triple point section 172, at which the longitudinal sealing joint 131 and the second traverse sealing joint 135 intersect, to seal the second triple point section 172. This is exemplarily illustrated in FIGS. 7 to 9.

For example, the first segment 701 and the second segment 702 may be sections of one continuous sealing strip 700, such as illustrated exemplarily in FIG. 8. Alternatively, the first segment 701 and the second segment 702 may be separate strips of the sealing strip 700, such as exemplarily illustrated in FIG. 9. At least part of the sealing strip 700 (and/or of the heat-sealed first segment 701 and/or of the heat-sealed second segment 702) may be sandwiched between the two side edge sections 111, 112 at the overlapping section 139. For instance, in FIG. 9, a configuration is illustrated where the sealing strip 700 may extend along the entire length of the overlapping section 139 while being sandwiched between the two side edge sections 111, 112. However, it is also conceivable that only one or more portions of the sealing strip 700 may be sandwiched between the two side edge sections 111, 112 at the overlapping section 139 while the heat-sealed first segment 701 and/or the heat-sealed second segment 702 may be provided away from the overlapping section 139. Preferably, the sealing strip 700 or at least (one of) the heat-sealed segment(s) 701, 702 may be arranged in the packaging 100—i.e. preferably at the overlapping section 139 between the two side edge sections 111, 112—such that it/they extend at least partially into the/their respective triple point section 171, 172. This is exemplarily illustrated in FIG. 7A.

A further aspect of the present invention relates to a machine 500 for producing the above described recyclable packaging 100 for enclosing the substance S. The illustrations of FIGS. 4 and 5 show examples for implementations of the machine 500. For example, the machine 500 may be a VFFS or HFFS machine. Moreover, the machine 500 may provide an implementation of the above described method for producing a recyclable packaging like the packaging 100.

The machine 500 comprises a first feeding system 510 for supplying the above described flat sheet 110. For example, the first feeding system 510 may comprises a sheet reel feeding system 511 for unrolling a longitudinal flat sheet material from a reel, such as the sheet reel 512, to supply the flat sheet 110. This is exemplarily illustrated in FIGS. 4A to 4D and FIGS. 5A to 5D.

The machine 500 comprises further a folding section 520 for folding the supplied flat sheet 110 so that the two opposite side edge sections 111, 112 of the flat sheet 110 overlap each other at the overlapping section 139 to form the flat sheet 110 into the tube 130. For example, the folding section 520 may comprise the folding tube 521, which preferably may comprise a collar or folding shoulder to fold the flat sheet 110 to the shape of the tube 130. This is exemplarily illustrated in FIGS. 4A to 4D and FIGS. 5A to 5D.

The machine 500 comprises further a filling section 560 for filling the tube 130 with a substance S to be packed. For example, the filling section 560 may comprise the filling tube 561 with the funnel portion 562. This is exemplarily illustrated in FIGS. 4A to 4D and FIGS. 5A to 5D.

The machine 500 comprises further a first heat sealing section 530 for heat sealing the tube 130 along the overlapping section 139 to form a longitudinal sealing joint 131. For example, the first heat sealing section 530 may comprise a preferably movable sealing part. For example, the first heating section 530 may comprise a sealing bar 531 as the sealing part that may be movable with respect to folding section 520 and the folding tube 521. The sealing part may be configured to cooperate with a counterpart in order to form the longitudinal sealing joint 131. For example, the counterpart may be provided by a portion of the folding section 520, such as a folding tube 521, or of the filling section 560, such as the filling tube 561. This is exemplarily illustrated in FIG. 5. However, it is also conceivable that the counterpart may be provided by a separate metal plate or otherwise. Alternatively, the counterpart may be provided by a second sealing part. This is exemplarily illustrated in FIGS. 4, where a pair of longitudinal sealing bars 532 is used to provide the longitudinal sealing joint 131.

The machine 500 comprises further a second heat sealing section 540 for heat sealing the tube 130 across the longitudinal sealing joint 131 to close the tube 130 with the first traverse sealing joint 134 at the first tube end 132. For example, a pair of traverse sealing bars 541, 542 may be provided such as exemplarily illustrated in FIGS. 4 and 5.

The machine 500 comprises further a third heat sealing section 550 for heat sealing the tube 130 across the longitudinal sealing joint 131 to close the tube 130 with the second traverse sealing joint 135 at the second tube end 133 so as to form the packaging 100. For example, a pair of traverse sealing bars may be provided such as exemplarily illustrated in FIGS. 4 and 5. Therein, it is also conceivable that the second heat sealing section 540 and the third heat sealing section 550 are provided integral or identical with each other. Preferably, the second or third heat sealing section 540, 550 may comprise separating means 555 to cut or weaken a portion of the tube 130 above the second traverse sealing joint 135 (with respect to direction of travel of the tube 130 through the machine 500) to separate consecutively produced packages 100 from each other. This is exemplarily illustrated in FIGS. 4A to 4D and FIGS. 5A to 5D.

The machine 500 comprises further a second feeding system 570 for supplying the sealing strip 700 such that the first segment 701 is provided at the first triple point section 171 so that the first segment 701 seals the first triple point section 171 upon the heat sealing of the tube 130 at the second heat sealing section 540 to form the first traverse sealing joint 134, and such that the second segment 702 is provided at the second triple point section 172 so that the second segment 702 seals the second triple point section 172 upon the heat sealing of the tube 130 at the third heat sealing section 550 to form the second traverse sealing joint 135.

Therein, the second feeding system 570 may be configured to supply at least part of the sealing strip 700 (and/or at least part of at least one of the respective segments 701, 702) at the respective triple point section 171, 172 so as to be sandwiched between the two side edge sections 111, 112 at the overlapping section 139.

The second feeding system 570 may comprise a film reel feeding system 571 for providing and arranging the sealing strip 700 at the folding section 520 between the two side edge sections 111, 112 and at the overlapping section 139. The film reel feeding system 571 may comprise the film reel 572 to unroll the sealing strip 700 therefrom. This is exemplarily illustrated in FIGS. 4 and 5. The sealing strip 700 may be guided towards the tube 130 along a direction traverse to the longitudinal axis of the tube 130 (FIG. 4) or along a direction parallel to the longitudinal axis of the tube 130 (FIG. 5). Thus, the film reel 572 may be turned by 90 degrees in FIG. 4 in comparison to the film reel 572 illustrated in FIG. 5.

The invention is not limited by the embodiments as described hereinabove, as long as being covered by the appended claims. All the features of the embodiments described hereinabove can be combined in any possible way and be provided interchangeably.

1. A method for producing a recyclable packaging for enclosing a substance, comprising:
providing a flat sheet made of a recyclable material and having two opposite side edge sections,
forming the flat sheet into a tube by folding the flat sheet so that the two side edge sections at least partially overlap each other at an overlapping section,
heat sealing the tube along the overlapping section to form a longitudinal sealing joint,
heat sealing the tube across the longitudinal sealing joint to close the tube with a first traverse sealing joint at a first tube end,
filling the tube with a substance to be packed,
heat sealing the tube across the longitudinal sealing joint to close the tube with a second traverse sealing joint at a second tube end opposite to the first tube end with respect to the substance to be packed so as to form the packaging enclosing said substance,
providing a heat-sealable sealing strip such that
a first segment of the sealing strip is provided at a first triple point section, at which the longitudinal sealing joint and the first traverse sealing joint intersect, and
a second segment of the sealing strip is provided at a second triple point section, at which the longitudinal sealing joint and the second traverse sealing joint intersect,
wherein the respective segments of the sealing strip seal the respective triple point section upon the heat sealing of the respective tube end to form the respective traverse sealing joint.

2. The method according to claim 1, wherein the respective segments of the sealing strip are provided before or during the step of forming the flat sheet into a tube, and/or before or during the step of heat sealing the longitudinal sealing joint.

3. The method according to claim 1, wherein at least part of the sealing strip is provided so that each of the respective segments is sandwiched between the two side edge sections at the overlapping section, preferably along the entire length of the overlapping section.

4. The method according to claim 1, wherein at least one of the steps of providing the respective segments comprises the step of arranging the respective segment at the overlapping section between the two side edge sections so that the respective segment extends to the respective triple point section.

5. The method according to claim 1, wherein at least one of the steps of providing the respective segments comprises the step of providing the respective segment at one of the two side edge sections.

6. The method according to claim 1, wherein the first segment and the second segment are sections of the sealing strip or are separate strips of the sealing strip, and
wherein the step of providing the sealing strip comprises the step of unrolling a strip of a film material from a film reel.

7. The method according to claim 1, wherein the sealing strip is made of a food grade material.

8. The method according to claim 1, wherein the sealing strip comprises a thickness in the range of 20 micrometres to 80 micrometres.

9. The method according to claim 1, wherein the step of providing the flat sheet comprises the step of unrolling a longitudinal flat sheet material from a sheet reel, and/or
wherein the flat sheet is made of a flat sheet material comprising a laminated or multilayered structure with a base layer made of a paper material or a recyclable plastic material.

10. A recyclable packaging being made of a flat sheet with two opposite side edge sections and made of a recyclable material, the packaging enclosing a substance and comprising:
a longitudinal sealing joint along an overlapping section, at which the two opposite side edge sections overlap each other when the flat sheet is folded to form the flat sheet into a tube,
a first traverse sealing joint extending across the longitudinal sealing joint to close the tube at a first tube end,
a second traverse sealing joint extending across the longitudinal sealing joint to close the tube at a second tube end opposite to the first tube end with respect to the enclosed substance,
the packaging comprising:
a sealing strip that is heat-sealable and that is provided such that
a heat-sealed first segment of the sealing strip is provided at a first triple point section, at which the longitudinal sealing joint and the first traverse sealing joint intersect, to seal the first triple point section, and
a heat-sealed second segment of the sealing strip is provided at a second triple point section, at which the longitudinal sealing joint and the second traverse sealing joint intersect, to seal the second triple point section.

11. The packaging according to claim 10, wherein at least part of the sealing strip is sandwiched between the two side edge sections at the overlapping section.

12. The packaging according to claim 10, wherein the side edge sections are facing each other with the same side of the flat sheet at the overlapping section, and
wherein the flat sheet comprises a laminated or multilayered structure comprising a base layer and a sealant layer.

13. The packaging according to claim 10, wherein the packaging is a multi-serve pack.

14. A machine for producing a recyclable packaging for enclosing a substance comprising:
a first feeding system for supplying a flat sheet made of a sheet material and having two opposite side edge sections,
a folding section for folding the supplied flat sheet so that the two opposite side edge sections overlap each other at an overlapping section to form the flat sheet into a tube,
a first heat sealing section for heat sealing the tube along the overlapping section to form a longitudinal sealing joint,
a second heat sealing section for heat sealing the tube across the longitudinal sealing joint to close the tube with a first traverse sealing joint at a first tube end,
a filling section for filling the tube with a substance to be packed,
a third heat sealing section for heat sealing the tube across the longitudinal sealing joint to close the tube with a second traverse sealing joint at a second tube end opposite to the first tube end with respect to the substance to be packed so as to form the packaging enclosing said substance,
a second feeding system for supplying a sealing strip such that
a first segment of the sealing strip is provided at a first triple point section, at which the longitudinal sealing joint and the first traverse sealing joint will intersect, so that the first segment seals the first triple point section upon the heat sealing of the tube at the second heat sealing section to form the first traverse sealing joint,
a second segment of the sealing strip is provided at a second triple point section, at which the longitudinal sealing joint and the second traverse sealing joint will intersect, so that the second segment seals the second triple point section upon the heat sealing of the tube at the third heat sealing section to form the second traverse sealing joint.

15. The machine according to claim 14, wherein
the second feeding system is configured to supply at least part of the sealing strip,
the second feeding system comprises a film reel feeding system for providing and arranging the sealing strip at the folding section between the two side edge sections and at the overlapping section,
the first feeding system comprises a sheet reel feeding system for unrolling a longitudinal flat sheet material from a sheet reel to supply the flat sheet,
the second heat sealing section and the third heat sealing section are integral or identical, and
wherein the first heat sealing section comprises a movable sealing part, which is configured to cooperate with a counterpart preferably provided by a portion of the folding section, such as a folding tube, or of the filling section in order to form the longitudinal sealing joint.
